(19) United States
(12) Patent Application Publication
(10) Pub. No.: US 2015/0216626 A1
(43) Pub. Date: Aug. 6, 2015

(54) Method For Placement Of Dental Attachments For Use With Dental Aligners

(71) Applicant: N. Daniel Ranjbar, Lawrence, KS (US)

(72) Inventor: N. Daniel Ranjbar, Lawrence, KS (US)

(21) Appl. No.: 14/171,071

(22) Filed: Feb. 3, 2014

(51) Int. Cl. A61C 7/08; A61C 9/00; A61C 7/00

(52) U.S. Cl. CPC A61C 7/08; A61C 7/002; A61C 9/004

(57) ABSTRACT

Dental attachments used with a series of transparent dental aligners are secured to the teeth in their desired locations before the transparent aligners are made. The attachments are pre-made and applied to the teeth as one of the first steps in the process of realigning the teeth. A computer model of the teeth, including the attachments secured to the teeth, is then made. The movements of the teeth are designated in the computer model. The series of individual transparent aligners are then designed and made for eventual application to the teeth in sequence to realign the teeth. The attachments may be made at any time in advance of their use and may contain removable handles for fast and easy placement on the teeth.

### FIELD OF INVENTION

The field of the invention is alignment devices for teeth and, more specifically, a method of installing prefabricated attachments for use with transparent teeth alignment devices.

### BACKGROUND

It is frequently desirable or necessary to change the alignment of human teeth to make the teeth more functional and/or more attractive. One type of alignment method frequently used to realign teeth is a series of transparent polyurethane alignment devices that fit over some or all of the teeth in the upper or lower dental arches of the mouth. Since the devices are transparent, the use of such devices allows the teeth to be realigned by devices that are much less noticeable to third person observers.

In order to make the transparent aligners, a three dimensional computer model of a patient's teeth is made. This may be done from a dental impression/mold. The Dentist or a third party scans the impression creating a digital model of the patient's teeth. The Dentist usually working with a third party technician designs the various stages of desired tooth movement which will allow for the fabrication of a series of transparent aligners to affect the desired change in the positions of the teeth. The series of transparent aligners are then made from the computer model allowing for a step by step progression to the desired final dental position. Each of the aligners has a slightly different pattern such that, when the aligners are placed over the teeth in sequence, the aligners apply forces to the teeth that progressively move and realign the teeth.

Certain realignment actions may be more difficult than others. Examples include tooth rotations and vertical (up or down) movements of teeth during treatment. Some teeth also may have rounded or other types of shapes that make it difficult for the transparent aligners to apply desired pressure. In such cases, the orthodontist will place attachments on the surfaces of the teeth to affect the designed or planned movements of the teeth. The attachments, which are attached to the teeth, make contact with the aligner allowing for more favorable directional force and retention in order to urge the affected teeth to rotate, move up or down, or make other movements.

The location of such attachments is something the orthodontist determines at the beginning of the treatment and before the aligners are actually made. There are also computer simulations that can advise the orthodontist regarding the placement of the attachments.

The placement of the attachments is typically done by the use of a separate plastic template that fits over the teeth. The template is typically made when the aligners are designed or at the time the aligners are manufactured. The template would be a passive aligner which contains reservoirs approximating the desired location of the attachment. These reservoirs are essentially a series of pockets or wells that are formed in the inside surface of the template at locations that correspond with the desired location for attachments on the patients teeth. In order to secure the attachments to the teeth the dentist prepares the teeth by first cleaning and isolating the attachment sites. Tooth colored filling material or composite material is then placed into the reservoirs or wells in the template. The template is then placed over the patient's teeth making sure the template is intimately positioned against teeth. The Dentist then “cures” the composite allowing for the composite material to harden and adhere firmly to the surface of the teeth. When the composite material is cured or becomes firm, the template is removed from the teeth, leaving the attachments (formed by the composite) firmly secured to the teeth. There is a high probability that the template reservoir will be either over filled or under filled with composite material. In either case there will typically be a clean up stage where the “flash” or excess material is removed and attachment is smoothed by with a handpiece (dental drill) or dental scaler. Thereafter, the next transparent aligner in the series may be placed on the teeth.

As is apparent from the above, the making of the aligners and attachments requires several time consuming steps in which error may occur. The relatively large number of steps also makes the process relatively expensive. The process of placement of the attachments may also introduce error if the appropriate amount of composite is not properly placed in the wells, is not mixed or cured properly, or the template is not seated properly and, consequently, attachment is not placed precisely on the desired location on the tooth. These potential errors will affect the ability of subsequent aligners to provide the desired tooth movement.

It would be beneficial to reduce the number steps in the making and placement of the attachments. It would also be beneficial to make the attachments to desired specifications, secure the attachments directly to the teeth before creating the three dimensional model of patients teeth and fabrication of transparent aligners. This would effectively eliminate the making and use of a separate template for the installation of the attachments to the teeth.

### SUMMARY OF THE INVENTION

Attachments are made in advance of their placement on the teeth. They may be made and purchased in bulk and stored until they are used. The attachments are directly and firmly secured to the teeth in the desired location by the orthodontist or dental clinician. The orthodontist or dental clinician then would either make an impression of or a scan the teeth to make a three dimensional computer model of the patient's teeth (which would include the installed attachments already in place). The desired movement or alignment of the teeth is determined digitally, and the series of individual transparent aligners is made and applied to the teeth in the proper sequence to align the teeth as desired.

The attachments made in advance may contain a handle or installation extension that makes them easier to place on the teeth. The handle or extension may have a weakened area at or near the junction of the handle and the attachment. The handle may then be twisted off or cut off after the attachment is secured to the tooth.

### BRIEF DESCRIPTION THE DRAWINGS

FIG. 1 is a schematic flow chart showing steps of the prior art method of making and using attachments.

FIG. 2 is a top view of an exemplary embodiment of an attachment used in the invention.

FIG. 3 is a side view of the attachment of FIG. 2.

FIG. 4 is a side view of the attachment of FIG. 2 connected to a handle.

FIG. 5 is a front view of a tooth on which the attachment of FIG. 2 has been secured.

FIG. 6 is a side view of a tooth on which the attachment of FIG. 2 has been secured.

### DETAILED DESCRIPTION

### Prior Art

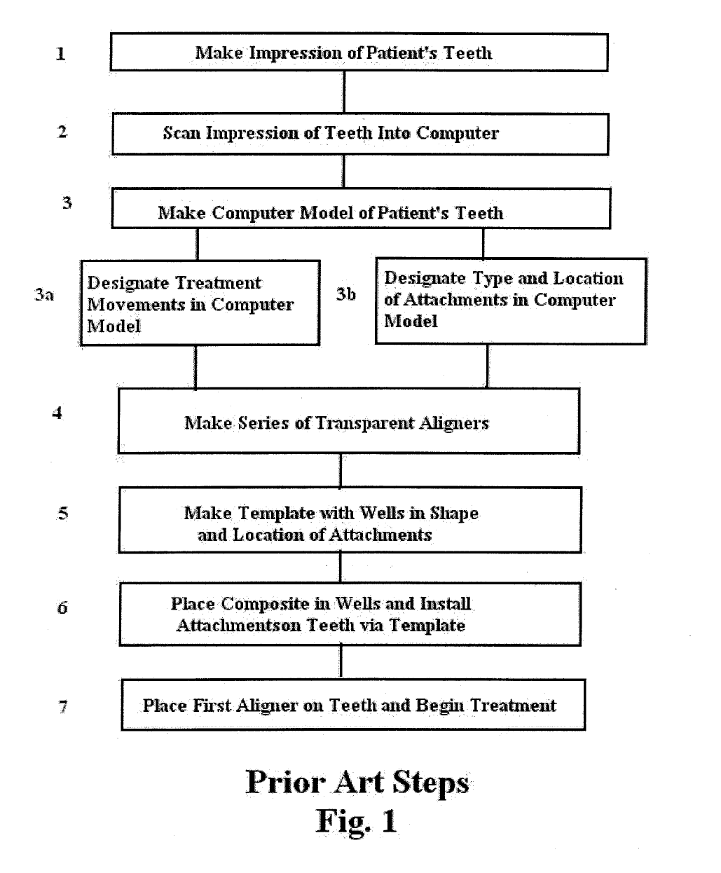

As shown in the schematic flow chart, FIG. 1, the prior art method of making and using attachment devices for teeth aligners is a multi-step process. The prior art steps and the approximate order in which the steps are performed, as shown on FIG. 1, are listed and described below.

Step 1. The dental clinician or orthodontist first makes an impression or scan of the patient's teeth.

Step 2. If a scan is not taken of teeth the impression is scanned into a computer.

Step 3. A three dimensional computer model is made of the patient's teeth from the impression or scan.

Step 3(a). The orthodontist in collaboration with the third party technician designs and designates the desired incremental treatment movements of the teeth in the computer model.

Step 3(b) The orthodontist in collaboration with the third party technician designates, in the computer model, the type and location attachments to be placed on the teeth.

Step 4. The series of transparent aligners may be made at this time to accomplish the series of incremental teeth movements designed and designated in the computer model in Step 3(a).

Step 5. Templates of the teeth are made at the time aligners are made. The templates, which are similar to the aligners, contain wells or pockets in the shape of the attachments that will be placed on the teeth.

Step 6. Composite is placed in the wells of the templates, and the templates are placed on the teeth. When on the teeth, the composite is cured or hardens and sticks to the teeth when the template is removed. The hardened composite remains on the teeth forming the attachments on the teeth.

Step 7. The first aligner is placed on the teeth, and the realigning of the teeth begins.

### Embodiments of the Invention

In the improved process, instead of making and using a template for the installation of the attachment, the attachments may be made separately in advance of their application to the teeth. The attachments may then be installed before a digital computer model is made, eliminating the steps related to the making and use of the template. The attachments may be made in different shapes for different purposes, fabricated to precision dimensions and shapes, and purchased in bulk in advance of their use.

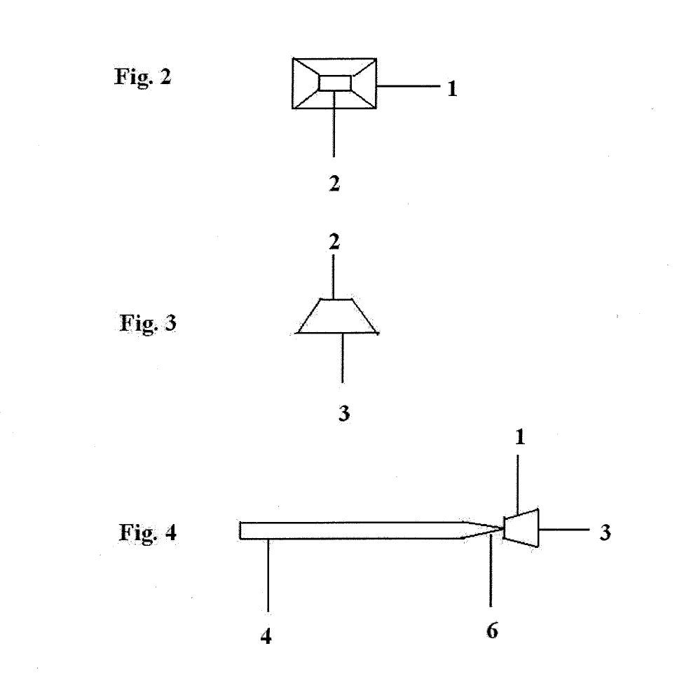

FIGS. 2 and 3 show, respectively, an enlarged top view and side view of an exemplary embodiment of an attachment . The attachment 1 shown is a four-sided pyramid with a flat top 2 and a flat base 3. The base 3 is secured or glued to the surfaces of teeth via a bonding agent. Attachments 1 typically have dimensions of about 1 mm in height and about 1.5 mm by 2.0 mm in length and width, but, obviously, the attachments 1 may be made in other dimensions and in other shapes for different purposes and shapes of teeth.

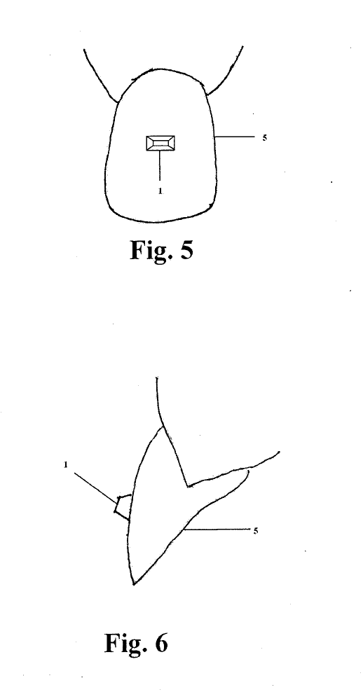

The attachments 1 are relatively small as compared to teeth. As shown in FIG. 4, the attachments 1 may be weakly connected to an elongated handle 4. The handle 4 may be used to maneuver the attachment 1 and place the base 3 of the attachment 1 in the desired location on a tooth 5 (see FIG. 5). The handle's 4 weak connection is a substantially narrowed handle end 6 secured to the attachment 1. Once the flat base 3 of the attachment 1 is secured to the tooth 5, the handle 4 is twisted to break the narrowed handle end 6 and separate it from the attachment 1. The narrowed handle end 6 may, if desired, also be cut from the attachment 1.

The attachments 1 are typically made of composite dental material that is commonly a synthetic resin containing fillers, coupling agents, and other materials. Catalysts may also be used with the composite materials to control the hardening or set up of the composite. Typically, such dental composites are insoluble, insensitive to dehydration, easy to manipulate, aesthetically pleasing, and reasonably inexpensive. Nevertheless, the attachments 1 may be made in a variety of other materials known in the art, including without limitation, plastics, nylons, and other materials that are biocompatible, aesthetic, and easy and economical to manufacture. Many such materials are known in the art. In general the attachment materials should have low thermal conductivity, resistance to chemical erosion, durable, and capable of bonding sufficiently to teeth, capable of withstanding everyday common masticatory forces, be able to coexist with the biological equilibrium of tooth and body systems, and match surrounding tooth structure shade and texture. The materials may also be selected for the optimal combination of the foregoing depending upon the circumstances.

As will be noted from the above, a variety of attachments 1 may be made prior to being secured to the teeth. They may be made in a large variety of materials and different shapes and sizes and may be easily and conveniently secured to the teeth 5. The attachments 1 may be sold in bulk to orthodontists for use at any desired time. Indeed, attachments of various shapes and designs may be made in advance to accommodate teeth of specific shapes or to most effectively cause specific types of teeth movements.

It will also be appreciated that such attachments 1 will make it unnecessary to make templates with wells or pockets for composite or other material that will bond to the teeth. Instead of making and applying the template to the patient's teeth to secure the attachments 1 to the teeth 5, the pre-made attachments 1 may be placed directly on the teeth 5 at any desired, convenient, or useful time or step prior to the process of realigning the teeth 5. And, specifically, the attachments 1 may be placed on the teeth 1 as a first step in the process and before the three dimensional computer model is made.

FIGS. 5 and 6 are front and side views respectively of the attachment 1 installed on the tooth 5 via use of the pre-made attachment 1 that is installed on the teeth by use of the handle 4 such as that described above.

In addition to eliminating the various steps in the making and use of the template for securing the attachments 1 to the teeth, the attachments 1 may be made more precisely, eliminating potential defects that can occur in the use of composite in the wells in the template, such as bubbles and spaces in the composite, and in incorrectly locating attachments on the teeth. The method will also render more reliable the method of placing the attachments 1 in the desired location on the teeth 5, as well as eliminate mistakes in designating locations of the attachments 1 in the computer model. Potential placement errors due to improper seating of template will also be eliminated.

In the improved method, the orthodontist, as a first step, places the pre-made attachments 1 in the desired locations on the teeth 5, eliminating steps 5 and 6 of the prior art method of installation.

As a second step, the orthodontist or dentist may take an impression of teeth which would then be scanned to create a three dimensional computer model of teeth or use a scanning device to directly make a three dimensional computer model of the patient's teeth which may be done by one of a variety of scanning devices currently on the market. As will be appreciated from the first step above, the attachments 1 will already be installed on the teeth and will be included the computer model produced in this step, eliminating the need for the use of an attachment template.

In a third step, the orthodontist may design and designate the various tooth movements desired to better align the teeth of the patient in a manner similar step 3(a).

In fourth and fifth steps, the series of transparent aligners are made and placed on the teeth in sequence to realign the teeth.

1. A method of making and installing tooth attachments for use with teeth aligners comprising:
(a) providing attachments for installation on teeth to be aligned;
(b) bonding the attachments to locations on the teeth to be realigned;
(c) making a computer model of the teeth containing the attachments;
(d) making a series of aligners for placement on the teeth in sequence; and
(e) installing the aligners on the teeth in the sequence;
wherein steps (a) through (e) are performed sequentially.

2. The method of claim 1 wherein the aligners are installed on the teeth by placing them over the teeth.

3. The method of claim 1 wherein the attachments are bonded to the teeth by applying adhesive material to at least one of the tooth and the attachment.

4. The method of claim 1 wherein the computer model is made by scanning or taking impression of the teeth in a mouth.

5. The method of claim 1 wherein the series of aligners is designed and made on the computer.

6. The method of claim 1 wherein the aligners are transparent.

7. The method of claim 1 wherein the attachments are made of at least one of a plastic, a resin, a composite, a nylon, or a polymer.

8. The method of claim 1 wherein the attachments have removable handles for placing the attachment on the teeth.

9. A method of making aligners for realigning teeth comprising:
(a) securing attachments for installation on teeth to be realigned;
(b) installing the attachments on the teeth to be realigned;
(c) making a computer model of the teeth and the installed attachments;
(d) making a series of aligners for placement on the teeth in sequence; and
(e) placing the aligners on the teeth in the sequence;
wherein steps (a) through (e) are performed sequentially.

10. The method of claim 9 wherein the aligners are installed on the teeth by placing them over the teeth.

11. The method of claim 9 wherein the attachments are bonded to the teeth by applying adhesive material to at least one of the tooth and the attachment.

12. The method of claim 9 wherein the computer model is made by scanning the teeth or taking impression of teeth in a mouth.

13. The method of claim 9 wherein the series of aligners is designed and made on the computer.

14. The method of claim 9 wherein the aligners are transparent.

15. The method of claim 9 wherein the attachments are made of at least one of an insoluble, easy to manipulate, plastic, synthetic resin, composite, nylon, or polymer.

16. The method of claim 9 wherein the attachments have removable handles for placing the attachment on the teeth.

17.-25. (canceled)
